(19) United States
(12) Patent Application Publication
(10) Pub. No.: US 2026/0030510 A1
(43) Pub. Date: Jan. 29, 2026

(54) IMAGE PROCESSING METHOD AND APPARATUS, ELECTRONIC DEVICE AND STORAGE MEDIUM

(71) Applicant: Lemon Inc., Grand Cayman (KY)

(72) Inventors: Yangyue Wan, Los Angeles, CA (US); Yichun Shi, Los Angeles, CA (US); Xiao Yang, Los Angeles, CA (US); Xiaohui Shen, Los Angeles, CA (US)

(21) Appl. No.: 18/873,469

(22) PCT Filed: Jun. 5, 2023
(86) PCT No.: PCT/SG2023/050401

§ 371 Date: Dec. 10, 2024

(30) Foreign Application Priority Data
Jun. 10, 2022 (CN) 202210658013.2

(51) Int. Cl. G06N 3/094; G06N 3/0455; G06T 11/60

(52) U.S. Cl. CPC G06N 3/094; G06N 3/0455; G06T 11/60

(57) ABSTRACT

Embodiments of the present disclosure provide an image processing method and apparatus, an electronic device and a storage medium. The method includes: obtaining an image to be processed; and inputting the image to be processed to an image attribute parameter changing model to obtain a target image, where a target attribute parameter value of the target image is different from a target attribute parameter value of the image to be processed, and the target attribute parameter value of the target image and the target attribute parameter value of the image to be processed correspond to different target attribute representation states.

The present disclosure claims the priority from the CN patent application Ser. No. 202210658013.2 filed with the China National Intellectual Property Administration on Jun. 10, 2022, the disclosure of which is hereby incorporated by reference in its entirety.

### FIELD

The present disclosure generally relates to the field of image processing technologies, and more specifically, to an image processing method and apparatus, an electronic device and a storage medium.

### BACKGROUND

For applications with an image editing function, different effects may be added to make images more interesting. During image editing, different effects, for example, hairstyles, or makeup, may be added to images to change attribute parameters in the images.

However, changing attribute parameters for different images is implemented by adding the same makeup or hairstyle effects, which can only achieve a simple effect; and the uniform makeup or hair accessories are not suitable for some images, leading to effects that are not natural or coordinated.

### SUMMARY

In view of the above, the present disclosure provides an image processing method and apparatus, an electronic device and a storage medium, where overall attribute parameters of an image can be changed based on features therein, to make the added effects more natural.

Embodiments of the present disclosure provide an image processing method, comprising: obtaining an image to be processed; and inputting the image to be processed to an image attribute parameter changing model to obtain a target image, wherein a target attribute parameter value of the target image is different from a target attribute parameter value of the image to be processed, and the target attribute parameter value of the target image and the target attribute parameter value of the image to be processed correspond to different target attribute representation states.

Embodiments of the present disclosure further provide an image processing apparatus, comprising: an image obtaining module configured to obtain an image to be processed; and an image processing module configured to input the image to be processed to an image attribute parameter changing model, to obtain a target image, wherein a target attribute parameter value of the target image is different from a target attribute parameter value of the image to be processed, and the target attribute parameter value of the target image and the target attribute parameter value of the image to be processed correspond to different target attribute representation states.

Embodiments of the present disclosure further provide an electronic device, comprising: at least one a processor; and a memory configured to store at least one program; wherein the at least one program, when executed by the at least one processor, causes the at least one processor to implement the image processing method of any of embodiments of the present disclosure.

Embodiments of the present disclosure provide a storage medium having computer executable instructions stored thereon, wherein the computer executable instructions, when executed by a computer processor, implement the image processing method of any of embodiments of the present disclosure.

### BRIEF DESCRIPTION OF THE DRAWINGS

FIG. 1 illustrates a flowchart of an image processing method provided by embodiments of the present disclosure;

FIG. 2 illustrates a flowchart of an image processing method provided by embodiments of the present disclosure;

FIG. 3 illustrates a schematic diagram of a training process for an image encoder provided by embodiments of the present disclosure;

FIG. 4 illustrates a schematic diagram of a structure of an image processing apparatus provided by embodiments of the present disclosure; and

FIG. 5 illustrates a schematic diagram of a structure of an electronic device provided by embodiments of the present disclosure.

### DETAILED DESCRIPTION OF EMBODIMENTS

Reference now will be made to the drawings to describe the embodiments of the present disclosure. Although the drawings illustrate some embodiments of the present disclosure, it would be appreciated that the present disclosure can be implemented in various forms, which should not be construed as being limited to the embodiments described herein. Rather, those embodiments are provided to enable a thorough and complete understanding of the present disclosure. The drawings and embodiments of the present disclosure are provided only exemplarily, without suggesting any limitation to the protection scope of the present disclosure.

It would be appreciated that respective steps in the method implementations according to the present disclosure may be performed in different orders and/or performed in parallel. In addition, the method implementations may include additional steps and/or steps omitted. The scope of the present disclosure is not limited thereto.

As used herein, the term “includes” and its variants are to be read as open-ended terms that mean “includes, but is not limited to.” The term “based on” is to be read as “based at least in part on.” The term “an embodiment” is to be read as “at least one embodiment;” the term “another embodiment” is to be read as “at least one further embodiment;” the term “some embodiments” is to be read as “at least some embodiments.” Related definitions of other terms will be provided in the description below.

It should be noted that, the terms “first,” “second” and the like mentioned in the present disclosure are only used to distinguish different apparatuses, modules or units, rather than limit an order of functions performed by the apparatus, module or unit or limit interdependence.

It should be noted that, the terms “one” and “a plurality of” mentioned in the present disclosure are illustrative, not restrictive, and should be understood as “at least one” by those skilled in the art, unless explicitly specified otherwise in the context.

Prior to applying the technical solution according to various embodiments of the present disclosure, the user should be informed of the type, scope of use, and use scenario of the personal information involved in an appropriate manner, and user authorization should be obtained.

For example, in response to receiving an active request from a user, prompt information is sent to the user to explicitly inform the user that the requested operation would acquire and use the user's personal information. Therefore, according to the prompt information, the user may decide on his/her own whether to provide the personal information to software or hardware, such as electronic devices, applications, servers, or storage media that perform operations of the technical solution of the present disclosure.

As an optional implementation, without limitation, in response to receiving an active request from a user, the method of sending prompt information to the user may, for example, include a pop-up window, where the prompt information may be presented in the form of text in the pop-up window. In addition, the pop-up window may also carry a select control for the user to choose to “agree” or “disagree” to provide the personal information to the electronic device.

The above process of notifying and obtaining the user authorization is only illustrative, not formulating any limitation to the implementations of the present disclosure, and other methods compliant with the provisions of the relevant laws and regulations can also be applied to the implementations of the present disclosure.

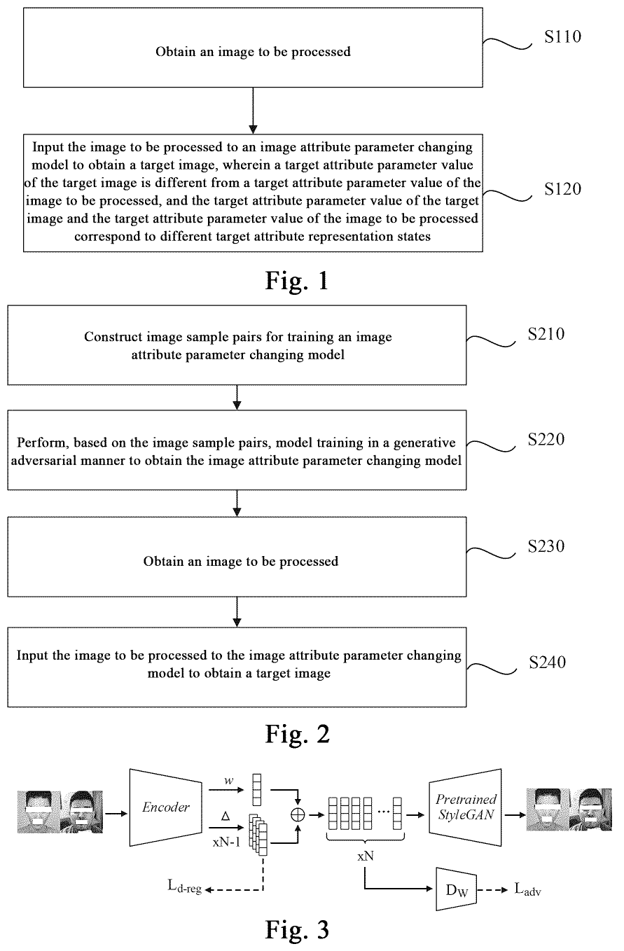

FIG. 1 is a flowchart of an image processing method provided by embodiments of the present disclosure. The embodiments of the present disclosure can be applied to the scenario of performing image processing based on an entirety of an image to be processed to change an image attribute. The method can be performed by an image processing apparatus, which can be implemented in the form of software and/or hardware, or by an electronic device that may be a mobile terminal, a Personal Computer (PC) or server, or the like.

As shown therein, the image processing method includes the following steps.

S110: obtaining an image to be processed.

The image to be processed may be an original image having an attribute to be changed, which may be an image acquired by downloading, capturing, uploading, or the like. In an image effect scenario where an attribute of an image to be processed needs to be changed, when detecting a trigger operation on an image effect, an image to be processed can be obtained as the target image processing object.

The image effect for changing an attribute of the image to be processed can be applied to any of applications capable of processing images or videos. It would be appreciated that image effect processing can be performed during a video shooting process or video call, to change the attribute of the image acquired in real time.

S120: inputting the image to be processed to an image attribute parameter changing model to obtain a target image, where a target attribute parameter value of the target image is different from a target attribute parameter value of the image to be processed, and the target attribute parameter value of the target image and the target attribute parameter value of the image to be processed correspond to different target attribute representation states.

After obtaining the image to be processed, the entire image to be processed is input as an object of the image processing into the image attribute parameter changing model to obtain a target image. In other words, feature extraction and analysis are performed on the entire object to be processed using the image attribute parameter changing model, and intermediate processing is performed based on the feature extraction result, to finally output a target image having a target attribute different from the original attribute of the image to be processed. As compared with the method of adding a effect for changing a target attribute to a local part of the image to be processed, the method according to this embodiment can make the effect of combining the change with the target attribute with the original image more natural and vivid.

The target attribute may be a pre-specified feature attribute of an object in the image to be processed, for example, a gender attribute, an age attribute, a hairstyle attribute, or the like, of a person in a person image. The gender attribute is taken as an example of the target attribute. Assumed that an object attribute parameter of a person in an image to be processed is classified as male, the image to be processed is input into the image attribute parameter changing model, and the image attribute parameter changing model then outputs a target image; correspondingly, the target image is an image where the gender attribute representation of the person object in the image to be processed is female. As compared with the method of adding to makeup effects such as red lips, long hair, and the like, to the face of the person with the gender attribute being male, the output of the image attribute parameter changing model according to this embodiment can implement the effect of “everybody is unique” because a processing process for each image to be processed is performed based on personal characteristics of a person object in the image, for example, hairstyle, hair color, facial features and the like. As such, a great diversity can be attained while the naturalness can be increased.

The image attribute parameter changing model may be a model obtained through training based on image sample pairs including images differing in target attribute representation state. The image with a target attribute representation state in the image sample pair may be used as an input of the training model while the image with another target attribute representation state is used as a desired output image of the trained model, and the model training is performed to obtain the image attribute parameter changing model applied in this embodiment.

In an optional implementation, model training may be performed based on an image sample pair including images differing in target attribute representation state in a generative adversarial manner to obtain the image attribute parameter changing model. For example, model training is performed using a Pix2Pix network architecture, such that the trained model can learn to “predict pixels based on pixels.”

The method of constructing image sample pairs may include: generating, by a pre-trained image generator, a plurality of original sample images, where target attribute representation states of the plurality of original sample samples may be the same, or may be different; then, performing feature encoding on each original sample image, and adjusting the target attribute parameter (target attribute feature) for the image feature encoding result to obtain a target encoded feature; finally, decoding, by the image generator that generated the original sample images, the target encoded feature to obtain a target sample image corresponding to the original sample image, i.e., an image obtained after adjusting the target attribute feature, which has a target attribute representation state different from the that of the original sample image. The process of constructing an image sample pair similarly includes: performing encoding processing based on overall features of the original sample images; then, adjusting the target attribute feature for the image feature encoding result; finally, obtaining a corresponding image sample pair. In this way, the image attribute parameter changing model can learn a mapping relationship between the image sample pair differing in attribute representation.

The pre-trained image generator may be an image generator obtained by training a StyleGAN model. In the training process of the StyleGAN model, the resolution of the generated image can be set, for example, to 1024*1024, and then, a plurality of high-definition and high-quality original sample images can be obtained. Correspondingly, the model obtained through training on the basis of the high-quality original sample images is capable of processing high-quality images to obtain a high-resolution image processing result. In addition, during the training process of the StyleGAN model, based on changes in the image attribute parameters modelled on the target attribute, the StyleGAN can use images with differing representations of the target attribute as references in its output images. This finally allows the StyleGAN model to generate a set of original sample images with varied representations of the target attribute, based on randomly sampled vectors of preset dimensions.

The technical solution according to the embodiments of the present disclosure includes: after obtaining the image to be processed, inputting the image to be processed to an image attribute parameter changing model to obtain a target image, where a target attribute parameter value of the target image is different from a target attribute parameter value of the image to be processed, and the target attribute parameter value of the target image and the target attribute parameter value of the image to be processed correspond to different target attribute representation states. Using the entire image to be processed as the processing object to change an image attribute, the embodiments of the present disclosure can solve the problem of an unnatural image attribute effect caused by the image attribute change implemented by only adding effects to a local part of the image in the related technologies, and can improve the image processing effect, making the image attribute changing result more natural.

FIG. 2 illustrates a flowchart of a further image processing method provided by embodiments of the present disclosure. The implementation process of the method includes a training process of an image attribute parameter changing model, and a construction process of training sample images. The method can be performed by an image processing apparatus, which can be implemented in the form of software and/or hardware, or by an electronic device that may be a mobile terminal, a Personal Computer (PC) or server, or the like.

As shown therein, the image processing method includes the following steps.

S210: constructing image sample pairs for training an image attribute parameter changing model.

Constructing image sample pairs for model training includes: constructing, based on original sample images generated by a pre-trained StyleGAN model, a feature mapping relationship between each original sample image and a target generated image with a different target attribute representation state corresponding to the original sample image, and using the constructed image sample pairs to guide the learning direction of the trained image attribute parameter changing model. Constructing image sample pairs specifically include the following steps.

Step I: performing, based on the pre-trained image generator, joint training on an image encoder to obtain a target image encoder which is capable of causing an image feature encoding result of an original encoded object image to be decoded, by the pre-trained image generator, into the original encoded object image.

The working process of the image attribute parameter changing model may be an image encoding and decoding process. At step I, a target image encoder is trained such that the image feature encoding result of the target image encoder can be correctly decoded by an image decoder, namely a pre-trained StyleGAN model (an image generator represented by Gs), to obtain a corresponding decoded original sample image.

Firstly, the original encoded object image (i.e., the original sample image) is input into the image encoder to obtain an image feature encoding vector of the original encoded object image; then, the image feature encoding vector of the original encoded object image is input respectively into an image generator and a preset discriminator; finally, the image encoder is updated based on a feature decoded image generated by the image generator based on the image feature encoding vector of the original encoded object image, and a discrimination result made by the preset discriminator on the image feature encoding vector of the original encoded object image and the training sampling vector of the image generator, to obtain a target image encoder. In this embodiment, solving a loss function employed in the training process of the image encoder includes not only solving a first loss function between the feature decoded image and the original encoded image, but also discriminating, by a preset discriminator arranged additionally, a second loss function between the image feature encoding vector of the original encoded object image and the training sampling vector of the image generator, such that the distribution features of the image feature encoding vector of the original encoded object image approximate those of the training sampling vector of the image generator. Therefore, the training effect can be improved. When the first loss function and the second loss function can simultaneously meet preset conditions, the training process of the image encoder can be completed to obtain a target image encoder.

By way of example, the training process of the target image encoder can be implemented with reference to FIG. 3. FIG. 3 shows two original sample images. The two original sample images are respectively input into an encoder, and the encoder then performs feature encoding on the input images to obtain a feature W. In addition, in order to enable the encoder to perform uniform random sampling on the input original sample images during the encoding process, a regularization mechanism is added to the training process of the encoder, where N is a number of regularization items, and L_{d-reg} is a loss function in the regularization process. An outcome obtained by aggregating the output result W of the encoder with the regularization result is multiplied by the numerical value N and then input into a pre-trained StyleGAN for feature decoding, to obtain an original encoded object image. In the feature decoding process, the features input into the StyleGAN are also input into the preset discriminator to discriminate a difference between the image feature encoding vector and the training sampling vector of the image generator, where the image feature encoding vector and the training sampling vector of the image generator are constrained by the loss function L_{adv}. The training sampling vector is an image feature vector for randomly sampling, by the image generator, the original sample images during training.

Step II: performing, by the target image encoder, feature encoding on each original sample image in the multiple original sample images with the different target attribute representation states generated by the pre-trained image generator, and determining, based on image feature encoding results of the multiple original sample images, a target attribute feature vector.

Through this step, the feature vector corresponding to the target attribute (the target attribute feature vector) can be determined. The original sample images are images with a known label, and the image feature encoding result (represented by W) obtained by encoding, by the target image encoder, each original sample image has a corresponding label. The gender attribute is still taken as an example of the target attribute. The image feature encoding result of each original sample image corresponds to a label W-male or W-female.

Through classification learning on image feature encoding results of multiple original sample images, a feature vector representing a target attribute can be extracted. For example, image feature encoding results of the multiple original sample images can be classified using a Support Vector Machine (SVM); then, a target attribute feature vector (represented by W′) that makes target attribute representation states of the multiple original sample images different is determined based on the classification result, to perform attribute decoupling on the target attribute. This is because SVM analyzes components of the feature encoding vector when learning and classifying the image feature encoding results of the multiple original sample images, and a primary component (i.e., a corresponding target attribute feature vector) capable of causing the classification results different can be extracted from a covariance matrix obtained during the component analysis process. The value of the target attribute feature vector is equivalent to a borderline of different target attribute representation states.

Step III: performing, based on the target attribute feature vector, target attribute parameter editing on an image feature encoding result of each original sample image, to obtain a changed image feature encoding result of each original sample image.

Editing the image feature encoding result based on the target attribute feature vector is a process of changing a value of a primary component feature vector affecting the classification result in the image feature encoding result, to change the target attribute representation state, including: for each image feature encoding result, determining an attribute editing weight value corresponding to the target attribute feature vector based on the target attribute representation state of the original sample image corresponding to the image feature encoding result; and aggregating the image feature encoding result with a product of the target attribute feature vector and the attribute editing weight value, to obtain a changed image feature encoding result, which can be represented as: the changed image feature encoding result=W+W′*α. α is an attribute editing weight value, which represents a direction and a degree of the target attribute representation state. The gender attribute is still taken as an example of the target attribute. α is a direction and an intensity of the gender. If α is positive, it is indicated that editing is performed towards the male direction; if α is negative, editing is performed towards the female direction. The absolute value of α represents the prominence of the gender characteristic, where the characteristic prominence is higher as the absolute value is greater. If the target attribute of the person in the original image is male, α is negative; if the target attribute of the person in the original image is female, α is positive. The absolute value of α may be a numerical value set according to the editing effect and the empirical value, which may be 2, for example.

Step IV: inputting the changed image feature encoding result of each original sample image into the pre-trained image generator, to obtain a target image corresponding to each original sample image and generate the image sample pair.

Finally, a target image with a target attribute representation state different from that of the original sample image can be obtained by inputting the image feature encoding result after the target attribute editing into the image generator, which can form, together with the original sample image, an image sample pair.

S220: performing, based on an image sample pair, model training in a generative adversarial manner to obtain the image attribute parameter changing model.

An image attribute parameter changing model capable of directly changing the target attribute representation state can be obtained by performing model training using the image sample pair obtained through the above step. An intermediate process of feature editing is omitted here, which can reduce the image processing time, allowing the image attribute parameter changing model to be applied in a broader range, for example, embedded into a corresponding image processing application for online use.

S230: obtaining an image to be processed.

S240: inputting the image to be processed into the image attribute parameter changing model to obtain a target image.

In the application process of the image attribute parameter changing model, if it is required to perform effect processing to change a target attribute value in an image, the image to be processed can be directly input into the image attribute parameter changing mode to obtain a corresponding target image with a different attribute representation state.

The technical solution according to embodiments of the present disclosure includes: generating, by a pre-trained image generator, multiple high-quality original sample images, performing feature extraction and feature editing on each original sample image to change a target attribute representation state, and finally decoding, by the image generator, the encoded feature after attribute editing to obtain a sample pair corresponding to each original sample image; and performing model training based on the sample pair to obtain an image attribute parameter changing model. In the application process of the image attribute parameter changing model, after obtaining an image to be processed, the image to be processed is directly input to the attribute parameter changing model, to obtain a target image, where a target attribute parameter value of the target image is different from that of the image to be processed, and the target attribute parameter value of the target image and the target attribute parameter value of the image to be processed correspond to different target attribute representation states. Using the entire image to be processed as the processing object to change an image attribute, the embodiments of the present disclosure can solve the problem of an unnatural image attribute effect caused by the image attribute change implemented by only adding effects to a local part of the image in the related technologies, and can implement the effect processing of “everybody is unique” and improve the image processing effect, making the image attribute changing result more natural.

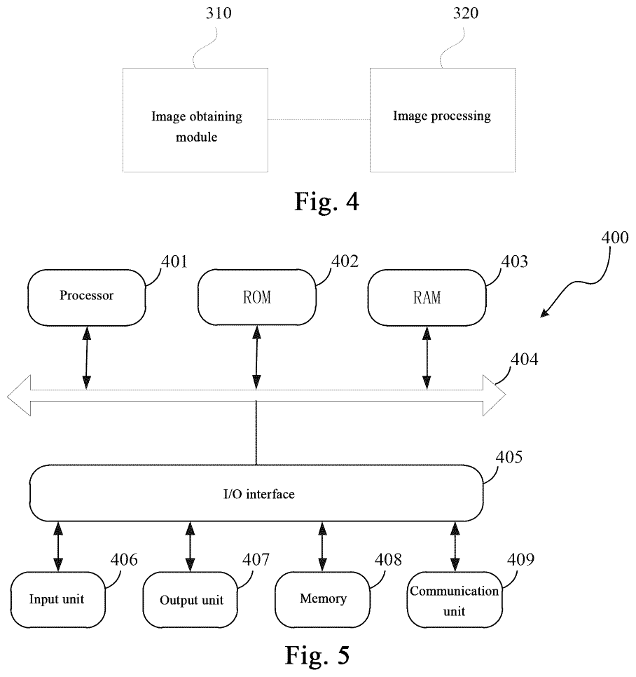

FIG. 4 illustrates a schematic diagram of a structure of an image processing apparatus provided by embodiments of the present disclosure. The apparatus can be applied to the scenario of performing image processing based on an entirety of an image to be processed to change image attributes, and can be implemented in the form of software and/or hardware. Alternatively, the image processing apparatus can be configured in an electronic device that may be a mobile terminal, a Personal Computer (PC) or server, or the like.

As shown therein, the image processing apparatus includes: an image obtaining module 310 and an image processing module 320.

the image obtaining module 310 configured to obtain an image to be processed; and the image processing module 320 configured to input the image to be processed to an image attribute parameter changing model, to obtain a target image, where a target attribute parameter value of the target image is different from a target attribute parameter value of the image to be processed, and the target attribute parameter value of the target image and the target attribute parameter value of the image to be processed correspond to different target attribute representation states.

The technical solution provided by embodiments of the present disclosure includes: obtaining an image to be processed; and inputting the image to be processed to an image attribute parameter changing model to obtain a target image, where a target attribute parameter value of the target image is different from a target attribute parameter value of the image to be processed, and the target attribute parameter value of the target image and the target attribute parameter value of the image to be processed correspond to different target attribute representation states. Using the entire image to be processed as the processing object to change an image attribute, the embodiments of the present disclosure can solve the problem of an unnatural image attribute effect caused by the image attribute change implemented by only adding effects to a local part of the image in the related technologies, and can improve the image processing effect, making the image attribute changing result more natural.

In an optional implementation, the image processing apparatus further includes a model training module configured to: perform, based on an image sample pair, model training in a generative adversarial manner to obtain the image attribute parameter changing model.

The image sample pair comprises an original sample image generated by a pre-trained image generator, and a target sample image corresponding to the original sample image, which is obtained by decoding, by the pre-trained image generator, target encoded features, wherein the target encoded features are features obtained by performing feature encoding on the original sample image and adjusting target attribute parameters for an image feature encoding result.

In an optional implementation, the image processing apparatus further includes a training sample construction model configured to: perform, based on the pre-trained image generator, joint training on an image encoder to obtain a target image encoder which is capable of causing an image feature encoding result of an original encoded object image to be decoded, by the pre-trained image generator, into the original encoded object image; perform, by the target image encoder, feature encoding on each original sample image in the multiple original sample images with the different target attribute representation states generated by the pre-trained image generator, and determining, based on image feature encoding results of the multiple original sample images, a target attribute feature vector; perform, based on the target attribute feature vector, target attribute parameter editing on an image feature encoding result of each original sample image, to obtain a changed image feature encoding result of each original sample image; and input the changed image feature encoding result of each original sample image into the pre-trained image generator, to obtain a target image corresponding to each original sample image and generate the image sample pair.

In an optional implementation, the training sample construction module is configured to: input the original encoded object image into an image encoder, to obtain an image feature encoding vector of the original encoded object image; input the image feature encoding vector of the original encoded object image into the pre-trained image generator and a preset discriminator, respectively; and update the image encoder based on a feature decoded image generated by the pre-trained image generator based on the image feature encoding vector of the original encoded object image, and a discrimination result of the pre-set discriminator about the image feature encoding vector of the original encoded object image and a training sampling vector of the pre-trained image generator, to obtain the target image encoder.

In an optional implementation, the training sample construction module is configured to: classify, by a support vector machine classifier, the image feature encoding results of the multiple original sample images; and determine, based on a classification result, a target attribute feature vector that varies the target attribute representation states of the multiple original sample images.

In an optional implementation, the training sample construction module is configured to: determine, based on a target attribute representation state of an original sample image corresponding to the image feature encoding result of each original sample image, an attribute editing weight value corresponding to the target attribute feature vector; and aggregate the image feature encoding result of each original sample image with a product of the target attribute feature vector and the attribute editing weight value, to obtain a changed image feature encoding result of each original sample image.

The image processing apparatus provided by embodiments of the present disclosure can perform the image processing method provided by any of the embodiments of the present disclosure, and includes corresponding functional modules for performing the method.

It is worth noting that a plurality of units and modules included in the above-mentioned apparatus is divided according to the functional logic, which are not confined to the above division as long as they can implement the respective functions. In addition, names of the plurality of functional units are employed only for differentiation from one another, without suggesting any limitation to the protection scope of the embodiments of the present disclosure.

FIG. 5 illustrates a schematic diagram of a structure of an electronic device 400 (e.g. a terminal device or a server in FIG. 5) adapted to implement embodiments of the present disclosure. The terminal device according to the embodiments of the present disclosure may include, but is not limited to, a mobile terminal such as a mobile phone, a laptop computer, a digital broadcast receiver, a Personal Digital Assistant (PDA), a Portable Android Device (PAD, a tablet computer), a Portable Multimedia Player (PMP), an on-vehicle terminal (e.g. an on-vehicle navigation terminal) or the like, or a fixed terminal such as a digital TV, a desktop computer or the like. The electronic device as shown in FIG. 5 is only an example, without suggesting any limitation to the functions and the application range of the embodiments of the present disclosure.

As shown therein, the electronic device 400 may include a processor (e.g. a central processor, a graphics processor or the like) 401, which can execute various acts and processing based on programs stored in a Read-Only Memory (ROM) 402 or a program loaded from a storage unit 408 to a Random Access Memory (RAM) 403. RAM 403 stores therein various programs and data required for operations of the electronic device 400. The processor 401, the ROM 402 and the RAM 403 are connected to one another via a bus 404. An input/output (I/O) interface 405 is also connected to the bus 404.

Typically, the following units may be connected to the I/O interface 405: an input unit 406 including, for example, a touchscreen, a touch pad, a keyboard, a mouse, a camera, a microphone, an accelerometer, a gyroscope and the like; an output unit 407 including, for example, a Liquid Crystal Display (LCD), a loudspeaker, a vibrator and the like; a storage unit 408 including, for example, a tape, a hard drive and the like; and a communication unit 409. The communication unit 409 can allow wireless or wired communication of the electronic device 400 with other devices to exchange data. Although FIG. 5 shows the electronic device 400 including various units, it would be appreciated that not all of the units as shown are required to be implemented or provided. Alternatively, more or fewer units may be implemented or provided.

According to embodiments of the present disclosure, the processes described above with reference to the flowcharts may be implemented as computer software programs. For example, embodiments of the present disclosure include a computer program product comprising computer programs carried on a computer readable medium, where the computer programs containing program code are used for performing the methods as in the flowcharts. In those embodiments, the computer programs may be downloaded and installed from a network via the communication unit 409, or may be installed from the storage unit 408, or may be installed from the ROM 402. The computer programs, when executed by the processor 401, perform the above-described functions defined in the method according to the embodiments of the present disclosure.

Names of messages or information interacted between a plurality of apparatuses in the embodiments of the present disclosure are illustrative rather than limit the scope of the messages or information.

The electronic device provided by the embodiments of the present disclosure belongs to the same invention concept as the image processing method provided by the above-mentioned embodiments. For the technical details not exhausted here, see the above-mentioned embodiments.

The embodiments of the present disclosure provide a computer storage medium having a computer program stored thereon, where the program, when executed by the processor, implements the image processing method provided by the above-mentioned embodiments.

It should be noted that the computer readable medium according to the present disclosure may be a computer readable signal medium or a computer readable storage medium or any combination of the two. The computer readable storage medium may be, for example, but not limited to, an electronic, magnetic, optical, electromagnetic, infrared, or semiconductor system, apparatus, or device, or any combination of the foregoing. More specific examples of the computer readable storage medium may include, but are not limited to: an electrical connection having one or more wires, a portable computer diskette, a hard disk, a Random Access Memory (RAM), a Random-Only Memory (ROM), an Erasable Programmable Read-Only Memory (EPROM or flash memory), an optical fiber, a portable Compact Disc Read-Only Memory (CD-ROM), an optical storage device, a magnetic storage device, or any suitable combination of the foregoing. In the present disclosure, a computer readable storage medium may be any tangible medium that can contain, or store, a program for use by or in connection with an instruction execution system, apparatus, or device. In contrast, in the present disclosure, a computer readable signal medium may include a propagated data signal with computer readable program code embodied therein, either in baseband or as part of a carrier wave. Such propagated data signal may take many forms, including, but not limited to, an electro-magnetic signal, an optical signal, or any suitable combination thereof. A computer readable signal medium may also be any computer readable medium that is not a computer readable storage medium and that can communicate, propagate, or transmit a program for use by or in connection with an instruction execution system, apparatus, or device. Program code embodied on a computer readable medium may be transmitted using any appropriate medium, including but not limited to: electrical wires, optical cables, RF (radio frequency), etc., or any suitable combination of the foregoing.

In some implementations, the client and the server may perform communication by using any known network protocol such as Hyper Text Transfer Protocol (HTTP) or any network protocol to be developed, and may connect with digital data in any form or carried in any medium (for example, a communication network). The communication network includes a Local Area Network (LAN), a Wide Area Network (WAN), an international network (for example, the internet), a peer-to-peer network (e.g. ad hoc peer-to-peer network), and any known network or network to be developed.

The computer-readable medium may be the one included in the electronic device, or may be provided separately, rather than assembled in the electronic device.

The computer-readable medium carries one or more programs which, when executed by the electronic device, cause the electronic device to: obtain an image to be processed; and input the image to be processed to an image attribute parameter changing model to obtain a target image, wherein a target attribute parameter value of the target image is different from a target attribute parameter value of the image to be processed, and the target attribute parameter value of the target image and the target attribute parameter value of the image to be processed correspond to different target attribute representation states.

Computer program code for performing operations of the present disclosure may be written by using one or more program design language or any combination. The program design language includes, but is not limited to, object oriented program design language such as Java, Smalltalk and C++, and further includes conventional process-type program design language such as “C” or similar program design language. The program code may be completely or partially executed on a user computer, performed as an independent software packet, partially executed on the user computer and partially executed on a remote computer, or completely executed on the remote computer or a server. In a case of involving the remote computer, the remote computer may connect to the user computer via any type of network such as a Local Area Network (LAN) and a Wide Area Network (WAN). Alternatively, the remote computer may connect to an external computer (such as achieving internet connection by services provided by the internet network service provider).

The flowchart and block diagrams in the drawings illustrate the architecture, functionality and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowcharts, and combinations of blocks in the block diagrams and/or flowcharts, can be implemented by special purpose hardware-based systems which perform the specified functions or acts, or combinations of special purpose hardware and computer instructions.

Related units for describing the embodiments of the present disclosure may be implemented in the form of software, or may be implemented in the form of hardware. In certain circumstances, the names of units/modules do not formulate limitation to the units per se.

The functions described above may be performed, at least in part, by one or more hardware logic components. For example, without limitation, exemplary types of hardware logic components that may be used include: Field Programmable Gate Arrays (FPGAs), Application Specific Integrated Circuits (ASICs), Application Specific Standard Products (ASSPs), Systems on Chip (SOCs), Complex Programmable Logic Devices (CPLDs), and the like.

In the context of this disclosure, a machine-readable medium may be a tangible medium that can contain or store a program for use by or in connection with an instruction execution system, apparatus, or device. The machine-readable medium may be a machine-readable signal medium or a machine-readable storage medium. A machine-readable medium may include, but is not limited to, an electronic, magnetic, optical, electromagnetic, infrared, or semiconductor system, apparatus, or device, or any suitable combination of the foregoing. More specific examples of a computer-readable storage medium would include an electrical connection based on one or more wires, a portable computer diskette, a hard disk, an RAM, an ROM, an EPROM or flash memory, an optical fiber, a CD-ROM, an optical storage device, a magnetic storage device, or any suitable combination of the foregoing.

According to one or more embodiments of the present disclosure, [Example I] provides an image processing method, comprising: obtaining an image to be processed; and inputting the image to be processed to an image attribute parameter changing model to obtain a target image, wherein a target attribute parameter value of the target image is different from a target attribute parameter value of the image to be processed, and the target attribute parameter value of the target image and the target attribute parameter value of the image to be processed correspond to different target attribute representation states.

According to one or more embodiments of the present disclosure, [Example II] provides an image processing method, further comprising: in some optional implementations, a training process for the image attribute parameter changing model comprises: performing, based on an image sample pair, model training in a generative adversarial manner to obtain the image attribute parameter changing model; wherein the image sample pair comprises an original sample image generated by a pre-trained image generator, and a target sample image corresponding to the original sample image, which is obtained by decoding, by the pre-trained image generator, target encoded features, wherein the target encoded features are features obtained by performing feature encoding on the original sample image and adjusting target attribute parameters for an image feature encoding result; wherein a target attribute representation state of the original sample image is different from a target attribute representation state of the target sample image corresponding to the original sample image.

According to one or more embodiments of the present disclosure, [Example III] provides an image processing method, comprising: in some optional implementations, the original sample image comprises multiple original sample images with different target attribute representation states generated by the pre-trained image generator; a process of generating the image sample pair comprises: performing, based on the pre-trained image generator, joint training on an image encoder to obtain a target image encoder which is capable of causing an image feature encoding result of an original encoded object image to be decoded, by the pre-trained image generator, into the original encoded object image; performing, by the target image encoder, feature encoding on each original sample image in the multiple original sample images with the different target attribute representation states generated by the pre-trained image generator, and determining, based on image feature encoding results of the multiple original sample images, a target attribute feature vector; performing, based on the target attribute feature vector, target attribute parameter editing on an image feature encoding result of each original sample image, to obtain a changed image feature encoding result of each original sample image; and inputting the changed image feature encoding result of each original sample image into the pre-trained image generator, to obtain a target image corresponding to each original sample image and generate the image sample pair.

According to one or more embodiments of the present disclosure, [Example IV] provides an image processing method, further comprising: in some optional implementations, performing, based on the pre-trained image generator, joint training on the image encoder, to obtain the target image encoder capable of causing the image feature encoding result of the original encoded object image to be decoded, by the pre-trained image generator, into the original encoded object image, comprises: inputting the original encoded object image into an image encoder, to obtain an image feature encoding vector of the original encoded object image; inputting the image feature encoding vector of the original encoded object image into the pre-trained image generator and a preset discriminator, respectively; and updating the image encoder based on a feature decoded image generated by the pre-trained image generator based on the image feature encoding vector of the original encoded object image, and a discrimination result of the pre-set discriminator about the image feature encoding vector of the original encoded object image and a training sampling vector of the pre-trained image generator, to obtain the target image encoder.

According to one or more embodiments of the present disclosure, [Example V] provides an image processing method, further comprising: in some optional implementations, determining, based on the image feature encoding results of the multiple original sample images, the target attribute feature vector comprises: classifying, by a support vector machine classifier, the image feature encoding results of the multiple original sample images; and determining, based on a classification result, a target attribute feature vector that varies the target attribute representation states of the multiple original sample images.

According to one or more embodiments of the present disclosure, [Example VI] provides an image processing method, further comprising: in some optional implementations, performing, based on the target attribute feature vector, target attribute parameter editing on the image feature encoding result of each original sample image, to obtain the changed image feature encoding result of each original sample image, comprises: determining, based on a target attribute representation state of an original sample image corresponding to the image feature encoding result of each original sample image, an attribute editing weight value corresponding to the target attribute feature vector; and aggregating the image feature encoding result of each original sample image with a product of the target attribute feature vector and the attribute editing weight value, to obtain a changed image feature encoding result of each original sample image.

According to one or more embodiments of the present disclosure, [Example VII] provides an image processing apparatus, further comprising: an image obtaining module configured to obtain an image to be processed; and an image processing module configured to input the image to be processed to an image attribute parameter changing model, to obtain a target image, wherein a target attribute parameter value of the target image is different from a target attribute parameter value of the image to be processed, and the target attribute parameter value of the target image and the target attribute parameter value of the image to be processed correspond to different target attribute representation states.

According to one or more embodiments of the present disclosure, [Example VIII] provides an image processing apparatus, further comprising: in some optional implementations, the image processing apparatus further comprises a model training module configured to: perform, based on an image sample pair, model training in a generative adversarial manner to obtain the image attribute parameter changing model; wherein the image sample pair comprises an original sample image generated by a pre-trained image generator, and a target sample image corresponding to the original sample image, which is obtained by decoding, by the pre-trained image generator, target encoded features, wherein the target encoded features are features obtained by performing feature encoding on the original sample image and adjusting target attribute parameters for an image feature encoding result; wherein a target attribute representation state of the original sample image is different from a target attribute representation state of the target sample image corresponding to the original sample image.

According to one or more embodiments of the present disclosure, [Example IX] provides an image processing apparatus, further comprising: in some optional implementations, the original sample image comprises multiple original sample images with different target attribute representation states generated by the pre-trained image generator; a process of generating the image sample pair comprises: performing, based on the pre-trained image generator, joint training on an image encoder to obtain a target image encoder which is capable of causing an image feature encoding result of an original encoded object image to be decoded, by the pre-trained image generator, into the original encoded object image; performing, by the target image encoder, feature encoding on each original sample image in the multiple original sample images with the different target attribute representation states generated by the pre-trained image generator, and determining, based on image feature encoding results of the multiple original sample images, a target attribute feature vector; performing, based on the target attribute feature vector, target attribute parameter editing on an image feature encoding result of each original sample image, to obtain a changed image feature encoding result of each original sample image; and inputting the changed image feature encoding result of each original sample image into the pre-trained image generator, to obtain a target image corresponding to each original sample image and generate the image sample pair.

According to one or more embodiments of the present disclosure, [Example X] provides an image processing apparatus, further comprising: in an optional implementation, the training sample construction module is configured to: input the original encoded object image into an image encoder, to obtain an image feature encoding vector of the original encoded object image; input the image feature encoding vector of the original encoded object image into the pre-trained image generator and a preset discriminator, respectively; and update the image encoder based on a feature decoded image generated by the pre-trained image generator based on the image feature encoding vector of the original encoded object image, and a discrimination result of the pre-set discriminator about the image feature encoding vector of the original encoded object image and a training sampling vector of the pre-trained image generator, to obtain the target image encoder.

According to one or more embodiments of the present disclosure, [Example XI] provides an image processing apparatus, further comprising: in an optional implementation, the training sample construction module is configured to: classify, by a support vector machine classifier, the image feature encoding results of the multiple original sample images; and determine, based on a classification result, a target attribute feature vector that varies the target attribute representation states of the multiple original sample images.

According to one or more embodiments of the present disclosure, [Example XII] provides an image processing apparatus, further comprising: in an optional implementation, the training sample construction module is configured to: determine, based on a target attribute representation state of an original sample image corresponding to the image feature encoding result of each original sample image, an attribute editing weight value corresponding to the target attribute feature vector; and aggregate the image feature encoding result of each original sample image with a product of the target attribute feature vector and the attribute editing weight value, to obtain a changed image feature encoding result of each original sample image.

The above have been provided only description on embodiments of the present disclosure and technical principles employed therein. Those skilled in the art should understand that the scope of the present disclosure is not limited to technical solutions formed by a specific combination of the above technical features, but covers other technical solutions formed by any combination of the above technical features or equivalent features thereof without departing from the concept of the present disclosure. For example, a technical solution formed by interchanging the above features with technical features having similar functions as disclosed (but not limited thereto) is also covered in the scope of the present disclosure.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular implementations. Certain features that are described in the context of separate embodiments may also be implemented in combination in a single embodiment. Conversely, various features that are described in the context of a single implementation may also be implemented in multiple embodiments separately or in any suitable sub-combination.

1. A method for processing an image, comprising:
obtaining an image to be processed; and
inputting the image to be processed to an image attribute parameter changing model to obtain a target image, wherein a target attribute parameter value of the target image is different from a target attribute parameter value of the image to be processed, and the target attribute parameter value of the target image and the target attribute parameter value of the image to be processed correspond to different target attribute representation states.

2. The method of claim 1, wherein a training process for the image attribute parameter changing model comprises:
performing, based on an image sample pair, model training in a generative adversarial manner to obtain the image attribute parameter changing model;
wherein the image sample pair comprises an original sample image generated by a pre-trained image generator, and a target sample image corresponding to the original sample image, which is obtained by decoding, by the pre-trained image generator, target encoded features, wherein the target encoded features are features obtained by performing feature encoding on the original sample image and adjusting target attribute parameters for an image feature encoding result;
wherein a target attribute representation state of the original sample image is different from a target attribute representation state of the target sample image corresponding to the original sample image.

3. The method of claim 2, wherein the original sample image comprises multiple original sample images with different target attribute representation states generated by the pre-trained image generator;
a process of generating the image sample pair comprises:
performing, based on the pre-trained image generator, joint training on an image encoder to obtain a target image encoder which is capable of causing an image feature encoding result of an original encoded object image to be decoded, by the pre-trained image generator, into the original encoded object image;
performing, by the target image encoder, feature encoding on each original sample image in the multiple original sample images with the different target attribute representation states generated by the pre-trained image generator, and determining, based on image feature encoding results of the multiple original sample images, a target attribute feature vector;
performing, based on the target attribute feature vector, target attribute parameter editing on an image feature encoding result of each original sample image, to obtain a changed image feature encoding result of each original sample image; and
inputting the changed image feature encoding result of each original sample image into the pre-trained image generator, to obtain a target image corresponding to each original sample image and generate the image sample pair.

4. The method of claim 3, wherein performing, based on the pre-trained image generator, joint training on the image encoder, to obtain the target image encoder capable of causing the image feature encoding result of the original encoded object image to be decoded, by the pre-trained image generator, into the original encoded object image, comprises:
inputting the original encoded object image into an image encoder, to obtain an image feature encoding vector of the original encoded object image;
inputting the image feature encoding vector of the original encoded object image into the pre-trained image generator and a preset discriminator, respectively; and
updating the image encoder based on a feature decoded image generated by the pre-trained image generator based on the image feature encoding vector of the original encoded object image, and a discrimination result of the pre-set discriminator about the image feature encoding vector of the original encoded object image and a training sampling vector of the pre-trained image generator, to obtain the target image encoder.

5. The method of claim 3, wherein determining, based on the image feature encoding results of the multiple original sample images, the target attribute feature vector comprises:
classifying, by a support vector machine classifier, the image feature encoding results of the multiple original sample images; and
determining, based on a classification result, a target attribute feature vector that varies the target attribute representation states of the multiple original sample images.

6. The method of claim 5, wherein performing, based on the target attribute feature vector, target attribute parameter editing on the image feature encoding result of each original sample image, to obtain the changed image feature encoding result of each original sample image, comprises:
determining, based on a target attribute representation state of an original sample image corresponding to the image feature encoding result of each original sample image, an attribute editing weight value corresponding to the target attribute feature vector; and
aggregating the image feature encoding result of each original sample image with a product of the target attribute feature vector and the attribute editing weight value, to obtain a changed image feature encoding result of each original sample image.

7. (canceled)

8. An electronic device, comprising:
at least one a processor; and
a memory configured to store at least one program;
wherein the at least one program, when executed by the at least one processor, causes the at least one processor to implement a method comprising:
obtaining an image to be processed; and
inputting the image to be processed to an image attribute parameter changing model to obtain a target image, wherein a target attribute parameter value of the target image is different from a target attribute parameter value of the image to be processed, and the target attribute parameter value of the target image and the target attribute parameter value of the image to be processed correspond to different target attribute representation states.

9. A non-transitory computer readable storage medium having a computer program stored thereon, wherein the program, when executed by a processor, implements a method comprising:
obtaining an image to be processed; and
inputting the image to be processed to an image attribute parameter changing model to obtain a target image, wherein a target attribute parameter value of the target image is different from a target attribute parameter value of the image to be processed, and the target attribute parameter value of the target image and the target attribute parameter value of the image to be processed correspond to different target attribute representation states.

10. The electronic device of claim 8, wherein a training process for the image attribute parameter changing model comprises:
performing, based on an image sample pair, model training in a generative adversarial manner to obtain the image attribute parameter changing model;
wherein the image sample pair comprises an original sample image generated by a pre-trained image generator, and a target sample image corresponding to the original sample image, which is obtained by decoding, by the pre-trained image generator, target encoded features, wherein the target encoded features are features obtained by performing feature encoding on the original sample image and adjusting target attribute parameters for an image feature encoding result;
wherein a target attribute representation state of the original sample image is different from a target attribute representation state of the target sample image corresponding to the original sample image.

11. The electronic device of claim 10, wherein the original sample image comprises multiple original sample images with different target attribute representation states generated by the pre-trained image generator;
a process of generating the image sample pair comprises:
performing, based on the pre-trained image generator, joint training on an image encoder to obtain a target image encoder which is capable of causing an image feature encoding result of an original encoded object image to be decoded, by the pre-trained image generator, into the original encoded object image;
performing, by the target image encoder, feature encoding on each original sample image in the multiple original sample images with the different target attribute representation states generated by the pre-trained image generator, and determining, based on image feature encoding results of the multiple original sample images, a target attribute feature vector;
performing, based on the target attribute feature vector, target attribute parameter editing on an image feature encoding result of each original sample image, to obtain a changed image feature encoding result of each original sample image; and
inputting the changed image feature encoding result of each original sample image into the pre-trained image generator, to obtain a target image corresponding to each original sample image and generate the image sample pair.

12. The electronic device of claim 11, wherein performing, based on the pre-trained image generator, joint training on the image encoder, to obtain the target image encoder capable of causing the image feature encoding result of the original encoded object image to be decoded, by the pre-trained image generator, into the original encoded object image, comprises:
inputting the original encoded object image into an image encoder, to obtain an image feature encoding vector of the original encoded object image;
inputting the image feature encoding vector of the original encoded object image into the pre-trained image generator and a preset discriminator, respectively; and
updating the image encoder based on a feature decoded image generated by the pre-trained image generator based on the image feature encoding vector of the original encoded object image, and a discrimination result of the pre-set discriminator about the image feature encoding vector of the original encoded object image and a training sampling vector of the pre-trained image generator, to obtain the target image encoder.

13. The electronic device of claim 11, wherein determining, based on the image feature encoding results of the multiple original sample images, the target attribute feature vector comprises:
classifying, by a support vector machine classifier, the image feature encoding results of the multiple original sample images; and
determining, based on a classification result, a target attribute feature vector that varies the target attribute representation states of the multiple original sample images.

14. The electronic device of claim 13, wherein performing, based on the target attribute feature vector, target attribute parameter editing on the image feature encoding result of each original sample image, to obtain the changed image feature encoding result of each original sample image, comprises:
determining, based on a target attribute representation state of an original sample image corresponding to the image feature encoding result of each original sample image, an attribute editing weight value corresponding to the target attribute feature vector; and
aggregating the image feature encoding result of each original sample image with a product of the target attribute feature vector and the attribute editing weight value, to obtain a changed image feature encoding result of each original sample image.

15. The non-transitory computer readable storage medium of claim 9, wherein a training process for the image attribute parameter changing model comprises:
performing, based on an image sample pair, model training in a generative adversarial manner to obtain the image attribute parameter changing model;
wherein the image sample pair comprises an original sample image generated by a pre-trained image generator, and a target sample image corresponding to the original sample image, which is obtained by decoding, by the pre-trained image generator, target encoded features, wherein the target encoded features are features obtained by performing feature encoding on the original sample image and adjusting target attribute parameters for an image feature encoding result;
wherein a target attribute representation state of the original sample image is different from a target attribute representation state of the target sample image corresponding to the original sample image.

16. The non-transitory computer readable storage medium of claim 15, wherein the original sample image comprises multiple original sample images with different target attribute representation states generated by the pre-trained image generator;
a process of generating the image sample pair comprises:
performing, based on the pre-trained image generator, joint training on an image encoder to obtain a target image encoder which is capable of causing an image feature encoding result of an original encoded object image to be decoded, by the pre-trained image generator, into the original encoded object image;
performing, by the target image encoder, feature encoding on each original sample image in the multiple original sample images with the different target attribute representation states generated by the pre-trained image generator, and determining, based on image feature encoding results of the multiple original sample images, a target attribute feature vector;
performing, based on the target attribute feature vector, target attribute parameter editing on an image feature encoding result of each original sample image, to obtain a changed image feature encoding result of each original sample image; and
inputting the changed image feature encoding result of each original sample image into the pre-trained image generator, to obtain a target image corresponding to each original sample image and generate the image sample pair.

17. The non-transitory computer readable storage medium of claim 16, wherein performing, based on the pre-trained image generator, joint training on the image encoder, to obtain the target image encoder capable of causing the image feature encoding result of the original encoded object image to be decoded, by the pre-trained image generator, into the original encoded object image, comprises:
inputting the original encoded object image into an image encoder, to obtain an image feature encoding vector of the original encoded object image;
inputting the image feature encoding vector of the original encoded object image into the pre-trained image generator and a preset discriminator, respectively; and
updating the image encoder based on a feature decoded image generated by the pre-trained image generator based on the image feature encoding vector of the original encoded object image, and a discrimination result of the pre-set discriminator about the image feature encoding vector of the original encoded object image and a training sampling vector of the pre-trained image generator, to obtain the target image encoder.

18. The electronic device non-transitory computer readable storage medium of claim 16, wherein determining, based on the image feature encoding results of the multiple original sample images, the target attribute feature vector comprises:
classifying, by a support vector machine classifier, the image feature encoding results of the multiple original sample images; and
determining, based on a classification result, a target attribute feature vector that varies the target attribute representation states of the multiple original sample images.

19. The non-transitory computer readable storage medium of claim 18, wherein performing, based on the target attribute feature vector, target attribute parameter editing on the image feature encoding result of each original sample image, to obtain the changed image feature encoding result of each original sample image, comprises:
determining, based on a target attribute representation state of an original sample image corresponding to the image feature encoding result of each original sample image, an attribute editing weight value corresponding to the target attribute feature vector; and
aggregating the image feature encoding result of each original sample image with a product of the target attribute feature vector and the attribute editing weight value, to obtain a changed image feature encoding result of each original sample image.
